(19) United States
(12) Patent Application Publication
(10) Pub. No.: US 2020/0298270 A1
(43) Pub. Date: Sep. 24, 2020

(54) CONTINUOUS COATING DEVICE AND CONTINUOUS COATING METHOD

(71) Applicant: TORAY ENGINEERING CO., LTD., Tokyo (JP)

(72) Inventors: Satoshi TOMOEDA, Otsu-shi, Shiga (JP); Yoshiyuki ARAI, Otsu-shi, Shiga (JP)

(21) Appl. No.: 16/086,099

(22) PCT Filed: Mar. 28, 2017
(86) PCT No.: PCT/JP2017/012524

§ 371 Date: Sep. 18, 2018

(30) Foreign Application Priority Data
Mar. 29, 2016 (JP) 2016-066544

(51) Int. Cl. B05C 11/10; B05C 5/02; B05D 1/26; B41M 7/00

(52) U.S. Cl. CPC B05C 11/1015; B41M 7/0018; B05D 1/26; B05C 5/0245

(57) ABSTRACT

A continuous coating device for continuously conveying a long film includes a coating roll, an imaging device and a coating head. The long film is wound onto the coating roll. The imaging device is configured to capture an image of a mark or a pattern on the long film wound onto the coating roll. The coating head is configured to coat the long film wound onto the coating roll with a specific pattern. The coating head is disposed downstream from the imaging device in a conveyance direction of the long film.

### CROSS-REFERENCE TO RELATED APPLICATIONS

This application is a U.S. National stage of International Application No. PCT/JP2017/012524 filed on Mar. 28, 2017. This application claims priority to Japanese Patent Application No. 2016-066544 filed with Japan Patent Office on Mar. 29, 2016. The entire disclosure of Japanese Patent Application No. 2016-066544 is hereby incorporated herein by reference.

### BACKGROUND

### Field of the Invention

The present invention relates to a continuous coating device and a continuous coating method for continuously coating a long film conveyed roll-to-roll with a coating liquid, and accurately forming a circuit pattern.

### Background Information

Conventionally, techniques such as sputtering, CVD, and photolithography have been known as ways to form a circuit pattern, but in recent years, techniques for forming a circuit pattern using various printing techniques (printed electronics) have been considered promising as a way to help lower costs, save energy, and consume fewer resources. Of these, a technique for forming a multilayer circuit pattern has been developed in which a metallic ink is dropped from an ink jet nozzle onto a substrate to form a circuit pattern, after which an insulating layer is applied in drops from the ink jet nozzle onto the substrate, and a metal ink is applied in drops onto the substrate from the ink jet nozzle.

Also, in order to coat a long film with a coating liquid, from the standpoint of production efficiency, it is common for the long film to be conveyed roll-to-roll and continuously coated. However, when the long film is conveyed and coated roll-to-roll, it is necessary for the coating to accommodate any distortion or expansion and contraction that may occur in the long film.

Japanese Patent Application Publication No. 2015-9951 (Patent Literature 1) discusses a configuration in which positioning is performed in a state in which a long film is held to a suction stage so that the coating is performed accurately, without any distortion occurring in the long film.

### SUMMARY

However, when a long film that has been conveyed roll-to-roll is first held against a suction stage and coated with a coating liquid, the conveyance ends up being no continuous but intermittent, and to strike a good takt balance in the drying process and other such post-processes, an accumulator or other such buffer must be provided, which is a problem of in that the manufacturing process becomes more involved.

It is an object of the present invention to solve the above problem by accurately coating a long film with a coating liquid while continuously conveying the long film roll-to-roll.

In order to solve the above problem, the present invention provides a continuous coating device for continuously conveying a long film and coating it with a specific pattern, the device comprising a coating roll onto which the long film is wound, an imaging device for capturing an image of a mark or a pattern on the long film wound onto the coating roll, and a coating head that coats the long film wound onto the coating roll with the specific pattern, wherein the coating head is provided downstream from the imaging device in the conveyance direction of the long film.

With this configuration, the long film can be accurately coated with the coating liquid while the long film is continuously conveyed roll-to-roll.

The length on the coating roll between the imaging position of the imaging device and the landing position of the coating liquid from the coating head may be greater than or equal to the length of the specific pattern of the long film.

This configuration allows distortion or expansion and contraction of the long film to be accurately measured, and allows the long film to be coated with the specific pattern very accurately.

A plurality of the coating heads may be provided in the conveyance direction of the long film, and the coating heads may be provided following the curvature of the coating roll so that the coating liquid will be discharged perpendicular to the long film wound onto the coating roll.

With this configuration, each of the plurality of coating heads can coat with the coating liquid with high accuracy.

A discharge cycle adjuster may be provided to adjust the landing position on the long film where the coating liquid discharged by the coating head lands, and the discharge cycle adjuster may calculate the expansion and contraction of the long film and adjust the discharge cycle of the coating liquid from the imaging result of the imaging device.

With this configuration, coating can be performed to accommodate any expansion and contraction of the long film.

A coating data adjuster may be provided to adjust the landing position on the long film where the coating liquid discharged by the coating head lands, and the coating data adjuster may calculate the expansion and contraction of the long film and adjust the coating data of the coating liquid from the imaging result of the imaging device.

With this configuration, coating can be performed to accommodate any expansion and contraction of the long film.

Also, to solve the above problem, the present invention is a continuous coating method for continuously conveying a long film and coating it with a specific pattern, the method comprising winding the long film onto a coating roll under tension, and capturing an image of a mark or pattern on the long film wound onto the coating roll with an imaging device, and coating the long film wound onto the coating roll with a specific pattern according to the expansion and contraction of the long film calculated from the imaging result of the imaging device.

With this configuration, the long film can be accurately coated with the coating liquid while the long film is continuously conveyed roll-to-roll.

With a simple configuration, a long film can be accurately coated with a coating liquid while the long film is continuously conveyed roll-to-roll.

### BRIEF DESCRIPTION OF THE DRAWINGS

FIG. 1 is a diagram illustrating the continuous coating device and the continuous coating method of the present invention;

FIG. 2 is a diagram illustrating an example of a long film in which a first insulating layer, a first layer circuit pattern, and a second insulating layer are laminated;

FIG. 3 is a diagram illustrating an example of a long film in which a second layer circuit pattern is laminated over the second insulating layer;

FIG. 4 is a top view illustrating a coating head in a first embodiment of the present invention;

FIG. 5 is a diagram illustrating the processing flow of a discharge cycle adjuster in the first embodiment of the present invention;

FIG. 6 is a diagram illustrating the processing flow of a coating data adjuster in a second embodiment of the present invention;

FIG. 7 is a top view illustrating the coating head in a fourth embodiment of the present invention; and

FIG. 8 is a top view illustrating the coating head in a fifth embodiment of the present invention.

### DETAILED DESCRIPTION OF EMBODIMENTS

### First Embodiment

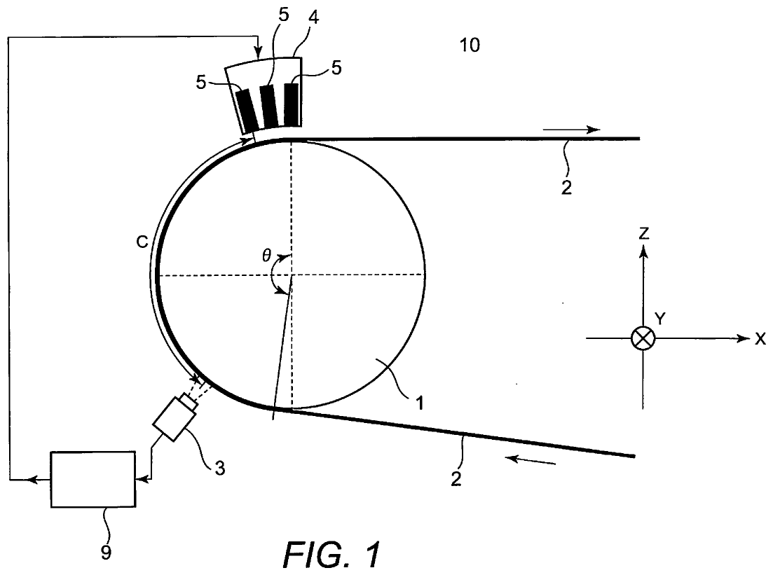

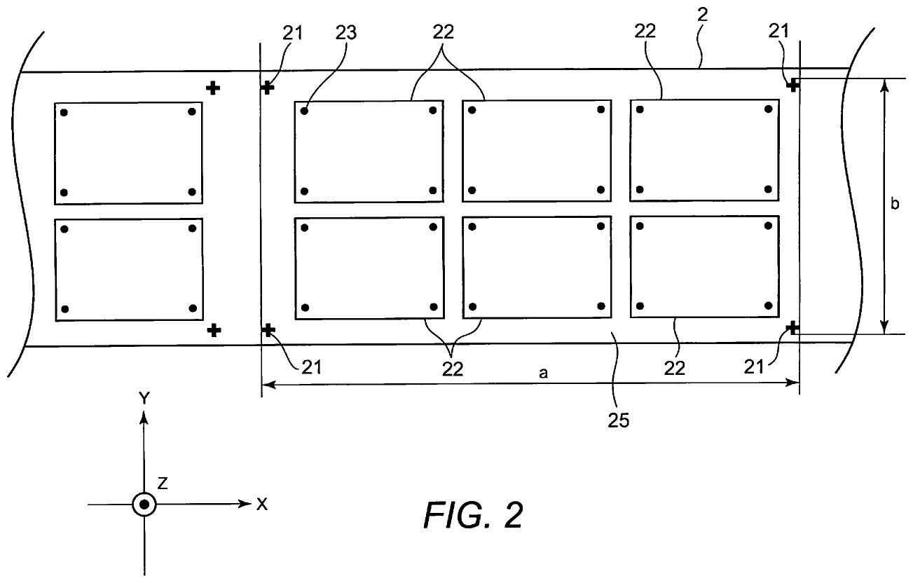

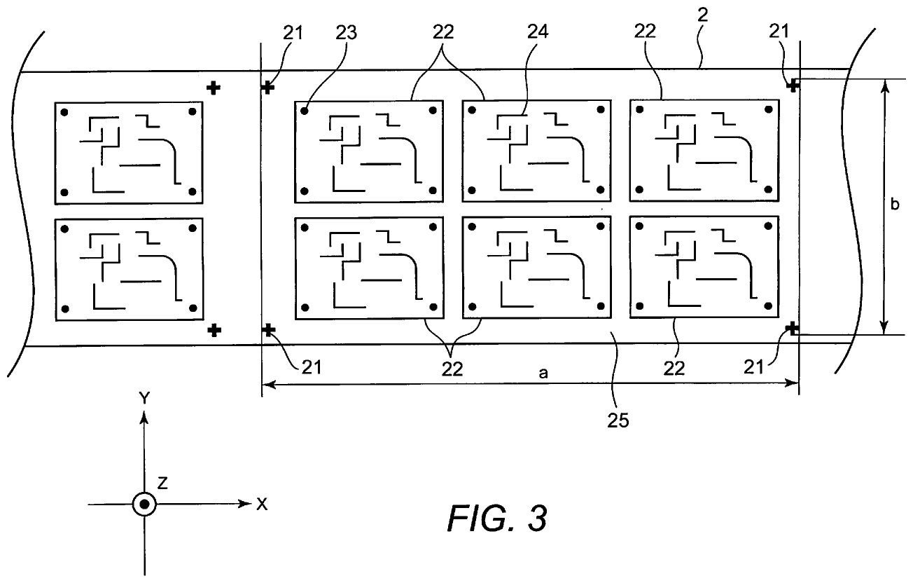

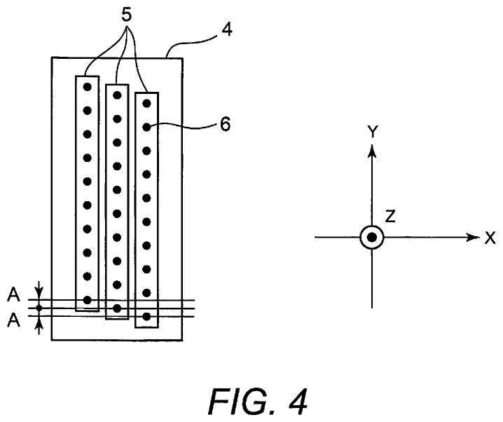

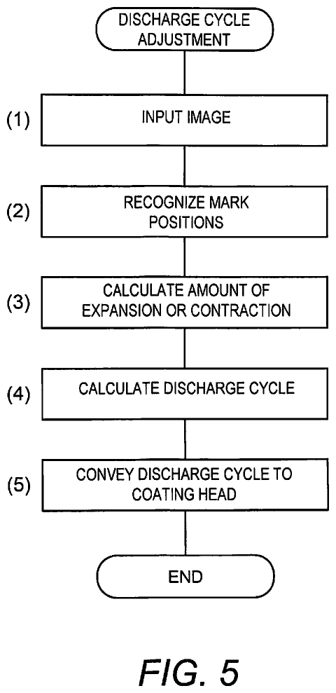

A first embodiment of the present invention will be described through reference to FIGS. 1 to 5. FIG. 1 is a diagram illustrating the continuous coating device and the continuous coating method of the present invention. FIG. 2 is a diagram illustrating an example of a long film in which a first insulating layer, a first layer circuit pattern, and a second insulating layer are laminated. FIG. 3 is a diagram illustrating an example of a long film in which a second layer circuit pattern is laminated over the second insulating layer. FIG. 4 is a top view illustrating the coating head in the first embodiment of the present invention. FIG. 5 is a diagram illustrating the processing flow of the discharge cycle adjuster in the first embodiment of the present invention.

As shown in FIG. 1, we will let the X direction be the conveyance direction of the long film 2, the Y direction be the width direction of the long film 2 perpendicular to the X direction, and the Z direction be a direction perpendicular to the X-Y plane constituted by the X direction and the Y direction. The long film 2 is conveyed by a roll-to-roll method in which it is unwound from an unwinding roll (not shown) and is wound on a winding roll (not shown), and is then routed from the approximate +X direction to the approximate −X direction (see FIG. 1) to a continuous coating device 10 positioned between the unwinding roll and the winding roll. The long film 2 conveyed to the continuous coating device 10 is wound onto a coating roll 1 in a state in which an appropriate tension is applied so that the long film does not sag. After being wound onto the coating roll 1, the long film 2 is continuously conveyed in the +X direction.

The coating roll 1 has a cylindrical shape and its central axis is disposed along the Y axis direction perpendicular to the conveyance direction of the long film 2 so that the long film will be wound smoothly. A rotary shaft running along this central axis is rotated. This rotary shaft is connected to a servomotor (not shown), and the coating roll 1 can be rotated and stopped by controlling the drive of this servomotor. Also, configuration is such that the long film 2 is wound onto the coating roll 1 from the approximate +X direction and conveyed in the +X direction so that the wrap angle θ of the long film 2 will be large enough. The greater is the wrap angle θ of the long film 2, the less slippage there will be and the more stable the conveyance will be, so this angle is set to about 120° to 180°. The cross-sectional diameter of the coating roll 1 has a large size (300 to 400 mm, for example) enough for the long film 2 to have a long winding length, and the length of the roll in the Y direction corresponds to the width of the long film 2.

In the first embodiment, the configuration is such that the long film 2 is guided from the approximate +X direction to the approximate −X direction and wound onto the coating roll 1, and then is continuously conveyed in the +X direction, but the conveyance direction is not necessarily limited to this, and can be suitably selected according to the requirements of the manufacturing process, so long as the long film 2 is onto the coating roll 1 so as to have a sufficiently large wrap angle θ, under enough tension that the long film 2 will not sag. For example, the configuration may be such that long film 2 is wound onto the coating roll 1 from the approximate −X direction and conveyed continuously in the −X direction, or may be wound onto the coating roll 1 from the approximate −Z direction and conveyed continuously in the approximate −Z direction.

The long film 2 conveyed to the continuous coating device 10 will now be described. First of all, a first insulating layer is first formed on the long film 2. A first layer circuit pattern including positioning marks is formed over the first insulating layer, a second insulating layer is formed over this, a second layer circuit pattern is formed over the second insulating layer, a third insulating layer is formed, a third layer circuit pattern is formed over the third insulating layer, a fourth insulating layer is formed over this, and a fourth layer circuit pattern is formed over the fourth insulating layer, thereby forming a circuit patterns in multiple layers. The positioning marks formed at the same time as the first layer circuit pattern are used so that the coating is done with good positioning accuracy, so as to correspond to the underlying circuit pattern when the pattern of each layer is formed, without being blocked by a subsequent insulating layer or circuit pattern.

The formation of the circuit patterns or the insulating layers may be performed by a method in which the long film 2 is continuously conveyed from the unwinding roll by roll-to-roll and goes through a number of continuous coating devices, such as when it goes through continuous coating device, a drying furnace, a continuous coating device, a drying furnace, a continuous coating device, and a drying furnace, after which the long film is wound onto the winding roll, or the layers may be formed by a batch method in which the unwinding roll is disposed at a pre-process of a single continuous coating device and a drying furnace and the winding roll are disposed at a post-process.

This will be described in specific terms, using as an example a case of forming the second layer circuit pattern. In this case, the first layer circuit pattern is formed over the first insulating layer (not shown) as shown in FIG. 2, but since the second insulating layer is formed over this, the first layer circuit pattern is not exposed on the surface. However, since the mark 21 and the mark 23 portions of the first layer circuit pattern are exposed from the second insulating layer, the second layer circuit pattern should be formed on the basis of this. Also, if there is another portion of the first layer circuit pattern that is exposed from the second insulating layer, it may be used as a positioning mark. Furthermore, if the second insulating layer is transparent, the underlying first layer circuit pattern can be seen through the second insulating layer, so any first layer circuit pattern may be used as a positioning mark.

An example of the second layer circuit pattern formed over the long film 2 will be described through reference to FIG. 3. As shown in FIG. 3, one specific pattern 25 is formed in the a×b area bounded by four marks 21, and six individual patterns 22 are formed in the area of the one specific pattern 25. A circuit pattern 24 is formed in each individual pattern 22. Specific patterns 25 are intermittently formed at specific intervals in the longitudinal direction (X direction) of the long film 2. Here, a “specific pattern” is a pattern serving as a unit that needs to be accurately coated with a coating liquid without being affected by distortion or expansion and contraction.

Although the specific pattern 25 includes six individual patterns 22 in the first embodiment, the present invention is not necessarily limited to this, and the configuration of the specific pattern 25 can be appropriately selected depending on the situation of the circuits. For example, a specific pattern 25 may include four individual patterns 22, or a specific pattern 25 may include seven or more individual patterns 22, or a specific pattern 25 may include just one individual pattern 22.

In the first embodiment, one mark 21 is provided at each of the four corners of the specific pattern 25, and there are four marks 23 for each individual pattern 22 in the first layer circuit pattern, but this is not necessarily the only option. The numbers can be appropriately selected depending on how much the long film expands and contracts, whether or not there is any meandering caused by conveyance, or the like. For example, two of each may be used, or more than four may be used. Furthermore, the marks 21 and the marks 23 are not essential, and if no marks 21 or marks 23 are formed and the first layer circuit pattern is exposed, position recognition (discussed below) can be used to recognize any exposed circuit pattern.

The description will continue by going back to FIG. 1. The long film 2 conveyed to the continuous coating device 10 is wound onto the coating roll 1. An imaging device 3 that captures an image of the specific pattern 25 of the long film 2 is provided downstream in the conveyance direction from the position where the long film 2 starts to be wound onto the coating roll 1. The imaging device 3 is a line sensor provided along the Y direction, and is capable of capturing an image of marks or patterns in the width direction (Y direction) of the long film 2, and as the long film 2 is conveyed, marks or patterns in the length direction (X direction) are sequentially imaged, and the entire area of the specific pattern 25 is eventually imaged.

In the first embodiment, the imaging device 3 is configured by a line sensor, but this is not necessarily the only option, and the type can be appropriately selected depending on the configuration of the device. For example, an area camera may be used so that the long film being conveyed is imaged using strobe light or an electronic shutter of a CMOS sensor. When an area camera is used, a plurality of places may be imaged by a plurality of area cameras, or one area camera may be configured to be movable so as to move over and an image a plurality of places.

A coating module 4 for coating the long film 2 wound onto the coating roll 1 with a coating liquid is provided on the downstream side of the imaging device 3 in the conveyance direction of the long film 2. The coating module 4 is equipped with inkjet coating heads 5, and discharges coating liquid from a plurality of nozzles 6 (see FIG. 4) of the coating heads 5 to perform coating of the specific pattern 25. The coating module 4 in the first embodiment is made up of three coating heads 5 arranged in the conveyance direction of the long film 2, and the nozzles 6 of each coating head 5 are arranged in the Y direction. Each of the coating heads 5 is provided following the curvature of the coating roll 1 so that the coating heads 5 discharge the coating liquid perpendicular to the long film 2 wound onto the coating roll 1. The distance from the discharge faces of the coating heads 5 to the surface of the long film 2 is set to about 500 μM to 1 mm.

In the first embodiment, the nozzles 6 of the coating heads 5 are arranged in the Y direction, but this is not necessarily the only option, and the arrangement direction can be appropriately selected as dictated by the device configuration. For example, the nozzles 6 of the coating heads 5 may be arranged in a zigzag pattern, or the nozzles 6 of the coating heads 5 may be arranged in the X direction (the conveyance direction of the long film 2), or the nozzles 6 of the coating heads 5 may be disposed slightly inclined with respect to the X direction or the Y direction. Here again, the coating heads are provided following the curvature of the coating roll 1 so that the coating liquid is discharged perpendicular to the long film 2 wound onto the coating roll 1.

Since the coating heads 5 are provided following the curvature of the coating roll 1 so as to discharge the coating liquid perpendicular to the long film 2 wound onto the coating roll 1, the coating liquid can be discharged accurately at the coating positions. Also, since the coating heads 5 are provided so that there is an appropriate distance from the discharge faces of the coating heads 5 to the surface of the long film 2, the coating liquid discharged from the coating heads 5 does not curve in flight, and instead flies straight, allowing it to land at the proper locations.

As shown in FIG. 4, the three coating heads 5 in the coating module 4 are provided in the X direction, and each coating head 5 has a plurality of nozzles 6 at a specific pitch. The coating heads 5 are provided so that the nozzles 6 of each coating head 5 are offset in the Y direction by an amount A corresponding to ⅓ of the nozzle pitch in one coating head 5. This allows the coating liquid to be applied at a resolution higher than the resolution of a single coating head 5.

In the first embodiment, the three coating heads 5 are offset by ⅓ of the nozzle pitch, but this is not necessarily the only option, and the layout can be appropriately selected as dictated by the required coating accuracy, the width of the long film 2, and so forth. For example, there may be two coating heads 5 that are offset by ½ of the nozzle pitch, or there may be four coating heads 5 that are offset by ¼ of the nozzle pitch.

The coating heads 5 are provided downstream from the long film 2 in the conveyance direction, with the landing position of the coating liquid separated from the imaging position of the imaging device 3 by the length c on the coating roll 1. The length c is greater than or equal to the length a in the conveyance direction (X direction) of the long film 2 in one specific pattern 25 (c≥a). In the first embodiment, the coating liquid landing position of the coating head 5 that is farthest upstream in the conveyance direction of the long film 2 out of the three coating heads 5 is provided downstream in the conveyance direction of the long film 2 and separated by the length c on the coating roll 1 from the imaging position of the imaging device 3. The reason for this is so that the marks 21 provided at the four corners of the region of the specific pattern 25 will be completely imaged by the imaging device 3 before starting coating of the specific pattern from the coating heads 5. That is, the length c on the coating roll 1 between the imaging position of the imaging device 3 and the landing position of the coating liquid from the coating heads 5 is greater than or equal to the length a of the specific pattern 25 of the long film 2. If no marks 21 are provided, the distance guided from the four corners of the specific pattern 25 may be used as the length a.

The image captured by the imaging device 3 is inputted to a controller 9 and subjected to image processing so as to convey the coating timing to the coating module 4. In the first embodiment, a discharge cycle adjuster (not shown) is provided in the controller 9, this discharge cycle adjuster calculates expansion and contraction of the long film 2 from the imaging result of the imaging device 3, and the landing position on the long film 2 where the coating liquid discharged by the coating head 5 lands is adjusted, so that the coating timing is conveyed to the coating module 4. Here, “discharge cycle” refers to the time difference from the start of one discharge until the start of the next discharge when the coating liquid is continuously discharged from one nozzle. For example, in coating data, when 100 discharge cycles are provided until the next discharge after discharge to a certain spot, the time difference between the two discharges is 10 msec when the discharge cycle is set to 100 μsec, and the time difference between the two discharges is 11 msec when the discharge cycle is set to 110 μsec. If this discharge cycle is extended, the specific pattern 25 can be extended without changing the coating data, and if the discharge cycle is shortened, the specific pattern 25 can be shortened without changing the coating data.

Adjustment of the discharge cycle is particularly effective for expansion and contraction in the conveyance direction. For example, if as a result of recognizing the positions of the four marks 21 on the long film 2 it is determined that the long film 2 has expanded to 303 mm with respect to 300 mm in the conveyance direction (X direction), the discharge cycle may be adjusted so as to expand it by 303/300 with respect to the conveyance direction (X direction).

A detailed processing flow of the discharge cycle adjustment performed by the discharge cycle adjuster will be described through reference to FIG. 5. First, a captured image is inputted from the imaging device 3 (FIG. 5(1)) to recognize the positions of the four marks 21 (FIG. 5(2)). Then, the distance a and the distance b between the marks 21 whose positions have been recognized are calculated, the difference from the set distance is found, and the amount of expansion or contraction of the long film 2 is calculated (FIG. 5(3)). Based on the calculated amount of expansion or contraction, as described above, the discharge cycle of the coating heads 5 is calculated (FIG. 5(4)) and the calculated discharge cycle is conveyed to the coating heads 5 (FIG. 5(5)).

In accordance with the conveyed discharge cycle, the coating heads 5 sequentially discharge the coating liquid from their nozzles 6 to perform coating of the specific pattern 25. Since the long film 2 is tightly wound onto the coating roll 1 and the coating heads 5 discharge the coating liquid perpendicular to the long film 2, the conveyance is not intermittent as in the past, the coating liquid can accurately land on the long film 2 while being continuously conveyed, and the coating of the specific pattern 25 can be accurately performed. This keeps the process from becoming too involved.

Also, if the coefficient of friction of the coating roll 1 and the wrap angle of the long film 2 on the coating roll 1 are sufficiently ensured, the long film 2 can be conveyed on the coating roll 1 up to the coating heads 5 without any deformation or meandering, so the coating heads 5 can accurately perform their coating on the basis of the information obtained by the imaging device 3. Here, if the long film 2 should be conveyed between the imaging device 3 and the coating heads 5 while away from the coating roll 1, the long film 2 may be deformed to the point that the coating heads 5 cannot accurately coat the long film.

As described above, the first embodiment of the present invention is a continuous coating device that continuously conveys a long film and coat it with a specific pattern, comprising a coating roll that winds the long film, an imaging device that captures an image of a mark or a pattern on the long film that is wound onto the coating roll, and coating heads that coat the long film wound onto the coating roll with a specific pattern, wherein the coating heads are provided on the downstream side of the imaging device in the conveyance direction of the long film. With this continuous coating device, the long film can be accurately coated with the coating liquid while the long film is continuously conveyed roll-to-roll.

Also, a continuous coating method for continuously conveying a long film and coating it with a specific pattern comprises winding the long film onto a coating roll under tension, capturing an image of a mark or pattern on the long film wound onto the coating roll with an imaging device, and coating the long film wound onto the coating roll with a specific pattern according to the expansion or contraction of the long film calculated from the imaging result of the imaging device. With this continuous coating method, the long film can be accurately coated with the coating liquid while the long film is being continuously conveyed roll-to-roll.

### Second Embodiment

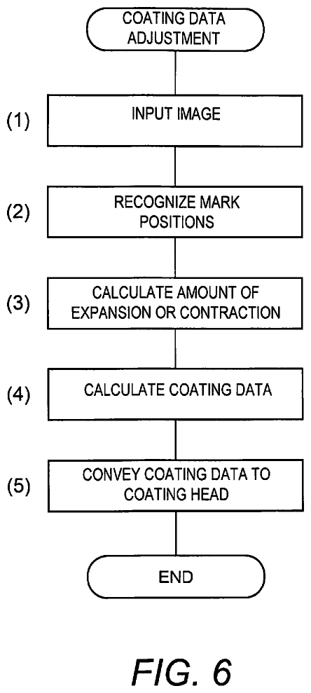

A second embodiment of the present invention will now be described. the second embodiment differs from the first embodiment only in that a coating data adjuster is provided to the controller 9 instead of the discharge cycle adjuster. the second embodiment will be described through reference to FIG. 6 is a diagram illustrating the processing flow of the coating data adjuster in the second embodiment of the present invention.

The coating data is basic data for perform coating with the coating liquid with the coating heads 5, and includes the position on the long film 2 where the coating liquid is to be discharged, the discharge amount, and the like. Adjusting this coating data makes it possible to alter the discharge position and discharge amount. The coating data adjuster adjusts the landing position on the long film 2, which is where the coating liquid discharged by the coating heads 5 lands. The processing flow of a specific coating data adjuster will now be described. First, the image captured by the imaging device 3 is inputted to a coating data adjuster (not shown) provided to the controller 9 (FIG. 6(1)). Next, position recognition of the four marks 21 is performed (FIG. 6(2)). Then, the distance a and the distance b between the recognized marks 21 are calculated, the difference from the set distance is calculated, and the amount of expansion or contraction of the long film 2 is calculated (FIG. 6(3)). Based on the calculated amount of expansion or contraction, new coating data for the coating heads 5 is calculated (FIG. 6(4)) and the newly calculated coating data is conveyed to the coating heads 5 (FIG. 6(5)).

For example, if as a result of recognizing the positions of the four marks 21 in the specific pattern 25 area it is determined that the long film 2 has expanded to 308 mm with respect to 300 mm in the width direction (Y direction) of the long film 2, the position data of discharge with respect to the width direction (Y direction) is adjusted in the coating data so as to be changed by 308/300.

Then, the coating heads 5 sequentially discharge the coating liquid from the nozzles 6 according to the conveyed new coating data, to perform coating of the specific pattern 25. Since the coating heads 5 are provided following the curvature of the coating roll 1 so as to discharge the coating liquid perpendicular to the long film 2 wound onto the coating roll 1, the coating liquid can accurately land on the long film 2, and the coating of the specific pattern 25 can be performed according to the amount of expansion or contraction.

### Third Embodiment

A third embodiment of the present invention will now be described. The third embodiment differs from the first embodiment only in that the coating data adjuster is also provided to the controller 9 in addition to the discharge cycle adjuster.

Specifically, the controller 9 comprises both a discharge cycle adjuster and a coating data adjuster. If the amount of expansion or contraction of the long film 2 is large, coating data adjustment is performed, and amount of expansion or contraction of the long film 2 is small, discharge cycle adjustment is performed. When discharge cycle adjustment is performed, the number of droplets applied does not change despite a change in the surface area of the coating region, so there is a decrease in coating resolution or a change in film thickness. Therefore, when high coating position accuracy and film thickness accuracy are required, coating data adjustment is performed. On the other hand, when the amount of expansion or contraction is small, discharge cycle adjustment is performed, in which a change entails less work. Also, when there is distortion, rather than simply expansion or contraction of the long film 2, coating data adjustment is performed, or both discharge cycle adjustment and coating data adjustment are performed.

Then, the coating heads 5 sequentially discharge the coating liquid from the nozzles 6 to form the specific pattern by adjusting the new coating data conveyed and/or adjusting the discharge cycle. Since the coating heads 5 are provided following the curvature of the coating roll 1 so as to discharge the coating liquid perpendicular to the long film 2 wound onto the coating roll 1, the coating liquid can accurately land on the long film 2, and a specific pattern according to the amount of expansion or contraction can be applied.

In the first to third embodiments, the position where the coating liquid was applied was adjusted by coating data adjustment and/or discharge cycle adjustment, but this is not necessarily the only option. For example, the coating module 4 may be configured to be movable, such as installing it on an XY robot, so that the coating position can be adjusted.

### Fourth Embodiment

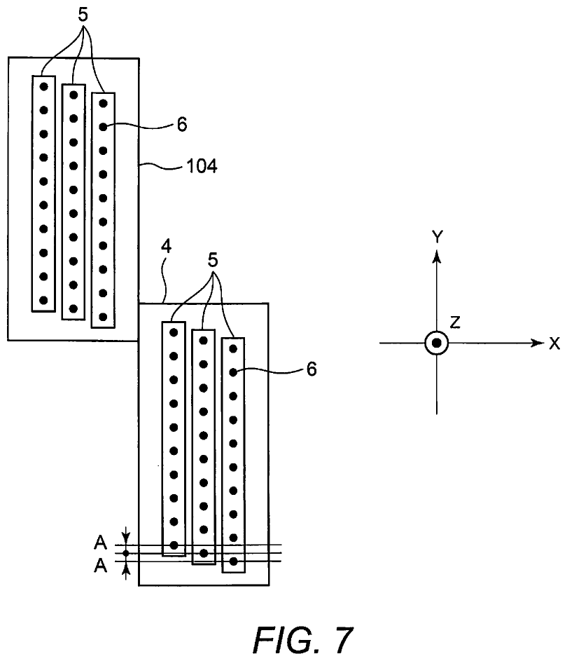

A fourth embodiment of the present invention will now be described through reference to FIG. 7. FIG. 7 is a top view of the coating heads in the fourth embodiment of the present invention. The fourth embodiment differs from the first embodiment in that a coating module 104 is provided in addition to the coating module 4.

Specifically, in the fourth embodiment, as shown in FIG. 7, in addition to the coating module 4 equipped with three coating heads 5, the coating module 104 equipped with three coating heads 5 is provided at a location that is offset in the X direction and the Y direction of the coating module 4. The reason for this is that the width (the length in the Y direction) of the long film 2 is greater, so it cannot be accommodated with just one coating module 4. The coating module 104 is disposed slightly overlapping the coating module 4 in the Y direction so that there will be no gap at the boundary between the coating module 4 and the coating module 104. In the fourth embodiment, the coating module 104 is disposed such that the nozzle 6 that is farthest in the −Y direction of the coating module 104 is disposed at a position offset by ⅓ pitch from the nozzle 6 that is farthest in the +Y direction of the coating module 4. This is not the only option, and the nozzle 6 that is farthest in the +Y direction of the coating module 4 may be disposed in the +Y direction relative to the nozzle that is farthest in the −Y direction of the coating module 104.

The coating module 104 is also an inkjet type of coating module, and forms the specific pattern 25 on the long film 2 by coating it with coating liquid. The coating module 104 in the fourth embodiment is made up of three coating heads 5 along the conveyance direction of the long film 2, each of which is provided in the Y direction. Also, the coating heads 5 are provided following the curvature of the coating roll 1 so as to discharge the coating liquid perpendicular to the long film 2 wound onto the coating roll 1. The distance from the discharge faces of the coating heads 5 to the surface of the long film 2 is set to about 500 μm to 1 mm.

### Fifth Embodiment

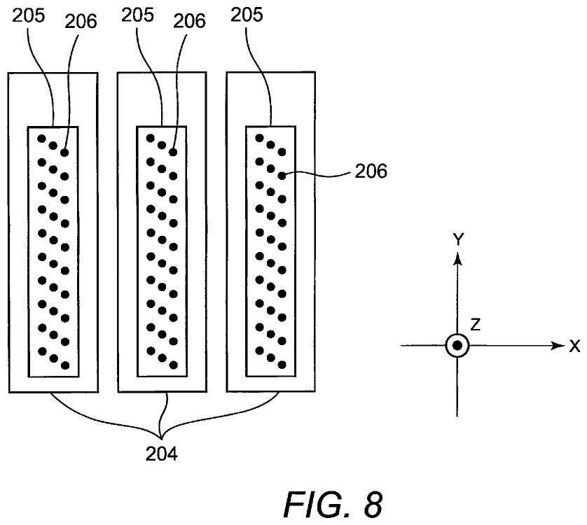

A fifth embodiment of the present invention will now be described through reference to FIG. 8. FIG. 8 is a top view of the coating heads in the fifth embodiment of the present invention. In the fifth embodiment, the structure and the number of coating modules are the only difference from the first embodiment.

Specifically, with the coating module 4 in the first embodiment, three coating heads 5 in which a plurality of nozzles 6 are arranged in a row in the X direction, but the coating module 204 in the fifth embodiment has coating heads 205 in which a plurality of nozzles 206 are arranged in the Y direction, and three rows of these are arranged in the X direction, offset from each other by ⅓ pitch. A coating module 204 is composed of a single coating head 205, and three coating heads 205 (that is, coating modules 204) are arranged in the X direction.

In each coating head 205, three rows of inkjet nozzles 206 are arranged in a fixed pattern, and the discharge ports of the middle nozzle row in the X direction are provided following the curvature of the coating roll 1. The discharge ports of the nozzle rows of at both ends, other than the middle row, do not actually follow the curvature of the coating roll 1, but since the spacing between the three nozzle rows is small, such as about 1 to 2 mm, the coating liquid can be discharged perpendicularly, with substantially no problem, onto the long film 2 wound onto the coating roll 1. Since the spacing between the coating heads 205 is several dozen millimeters, the coating heads 205 are provided following the curvature of the coating roll 1, using the discharge ports in the middle nozzle row as a reference, so that the coating liquid will be discharge perpendicular to the long film 2 wound onto the coating roll 1. Consequently, the coating liquid can be discharged accurately to each coating position. The distance from the discharge faces of the coating heads 205 to the surface of the long film 2 is set to about 500 μm to 1 mm.

In the fifth embodiment, three nozzle rows are provided to each coating head, one coating head constitutes one coating module, and the coating modules are arranged in three rows, but this is not necessarily the only option, the number of rows of each can be appropriately selected as dictated by the required resolution, the cost, and so on. For example, the configuration may be such that two nozzle rows constitute a coating head, two coating heads constitute a coating module, and the coating modules are arranged in two rows, or four or more nozzle rows may constitute a coating heads, four or more coating heads may constitute a coating module, and the coating modules may be arranged in four or more rows. Furthermore, in addition to or instead of the configuration of the fifth embodiment, a plurality of coating modules 204 may be arranged in the Y direction.

Here again, the fifth embodiment of the present invention is a continuous coating device that continuously conveys a long film and coats it with a specific pattern, comprising a coating roll that winds the long film, an imaging device that captures an image of a mark or a pattern on the long film that is wound onto the coating roll, and coating heads that coat the long film wound onto the coating roll with a specific pattern, wherein the coating heads are provided on the downstream side of the imaging device in the conveyance direction of the long film. With this continuous coating device, the long film can be accurately coated with the coating liquid while the long film is continuously conveyed roll-to-roll.

Also, a continuous coating method for continuously conveying a long film and coating it with a specific pattern comprises winding the long film onto a coating roll under tension, capturing an image of a mark or pattern on the long film wound onto the coating roll with an imaging device, and coating the long film wound onto the coating roll with a specific pattern according to the expansion or contraction of the long film calculated from the imaging result of the imaging device. With this continuous coating method, the long film can be accurately coated with the coating liquid while the long film is being continuously conveyed roll-to-roll.

The continuous coating device and continuous coating method of the present invention can be widely applied to the formation of various patterns on a long film continuously conveyed roll-to-roll.

1. A continuous coating device for continuously conveying a long film, the continuous coating device comprising:
a coating roll onto which the long film is wound;
an imaging device configured to capture an image of a mark or a pattern on the long film wound onto the coating roll; and
a coating head configured to coat the long film wound onto the coating roll with a specific pattern,
the coating head being disposed downstream from the imaging device in a conveyance direction of the long film.

2. The continuous coating device according to claim 1, wherein
a length between an imaging position of the imaging device and a landing position of the coating liquid from the coating head along the coating roll is greater than or equal to a length of the specific pattern of the long film.

3. The continuous coating device according to claim 1, wherein
a plurality of the coating heads are provided in the conveyance direction of the long film, and
the coating heads are provided following a curvature of the coating roll such that the coating liquid is discharged perpendicular to the long film wound onto the coating roll.

4. The continuous coating device according to claim 1, further comprising
a discharge cycle adjuster configured to adjust a landing position on the long film where the coating liquid discharged by the coating head lands, the discharge cycle adjuster being further configured to calculate expansion and contraction of the long film and configured to adjust a discharge cycle of the coating liquid based on an imaging result of the imaging device.

5. The continuous coating device according to claim 1, further comprising
a coating data adjuster configured to adjust a landing position on the long film where the coating liquid discharged by the coating head lands, the coating data adjuster being further configured to calculate expansion and contraction of the long film and configured to adjust a coating data of the coating liquid based on an imaging result of the imaging device.

6. A continuous coating method, comprising:
winding a long film onto a coating roll under tension;
continuously conveying the long film;
capturing an image of a mark or pattern on the long film wound onto the coating roll with an imaging device; and
coating the long film wound onto the coating roll with a specific pattern according to expansion and contraction of the long film calculated based on an imaging result of the imaging device.

7. The continuous coating device according to claim 2, wherein
a plurality of the coating heads are provided in the conveyance direction of the long film, and
the coating heads are provided following a curvature of the coating roll such that the coating liquid is discharged perpendicular to the long film wound onto the coating roll.

8. The continuous coating device according to claim 2, further comprising
a discharge cycle adjuster configured to adjust the landing position on the long film where the coating liquid discharged by the coating head lands, the discharge cycle adjuster being further configured to calculate expansion and contraction of the long film and configured to adjust a discharge cycle of the coating liquid based on an imaging result of the imaging device.

9. The continuous coating device according to claim 3, further comprising
a discharge cycle adjuster configured to adjust a landing position on the long film where the coating liquid discharged by the coating head lands, the discharge cycle adjuster being further configured to calculate expansion and contraction of the long film and configured to adjust a discharge cycle of the coating liquid based on an imaging result of the imaging device.

10. The continuous coating device according to claim 7, further comprising
a discharge cycle adjuster configured to adjust the landing position on the long film where the coating liquid discharged by the coating head lands, the discharge cycle adjuster being further configured to calculate expansion and contraction of the long film and configured to adjust a discharge cycle of the coating liquid based on an imaging result of the imaging device.

11. The continuous coating device according to claim 2, further comprising
a coating data adjuster configured to adjust the landing position on the long film where the coating liquid discharged by the coating head lands, the coating data adjuster being further configured to calculate expansion and contraction of the long film and configured to adjust a coating data of the coating liquid based on an imaging result of the imaging device.

12. The continuous coating device according to claim 3, further comprising
a coating data adjuster configured to adjust a landing position on the long film where the coating liquid discharged by the coating head lands, the coating data adjuster being further configured to calculate expansion and contraction of the long film and configured to adjust a coating data of the coating liquid based on an imaging result of the imaging device.

13. The continuous coating device according to claim 4, further comprising
a coating data adjuster configured to adjust the landing position on the long film where the coating liquid discharged by the coating head lands, the coating data adjuster being further configured to calculate the expansion and contraction of the long film and configured to adjust a coating data of the coating liquid based on the imaging result of the imaging device.

14. The continuous coating device according to claim 7, further comprising
a coating data adjuster configured to adjust the landing position on the long film where the coating liquid discharged by the coating head lands, the coating data adjuster being further configured to calculate expansion and contraction of the long film and configured to adjust a coating data of the coating liquid based on an imaging result of the imaging device.

15. The continuous coating device according to claim 8, further comprising
a coating data adjuster configured to adjust the landing position on the long film where the coating liquid discharged by the coating head lands, the coating data adjuster being further configured to calculate the expansion and contraction of the long film and configured to adjust a coating data of the coating liquid based on the imaging result of the imaging device.

16. The continuous coating device according to claim 9, further comprising
a coating data adjuster configured to adjust the landing position on the long film where the coating liquid discharged by the coating head lands, the coating data adjuster being further configured to calculate the expansion and contraction of the long film and configured to adjust a coating data of the coating liquid based on the imaging result of the imaging device.

17. The continuous coating device according to claim 10, further comprising
a coating data adjuster configured to adjust the landing position on the long film where the coating liquid discharged by the coating head lands, the coating data adjuster being further configured to calculate the expansion and contraction of the long film and configured to adjust a coating data of the coating liquid based on the imaging result of the imaging device.
